(19) United States
(12) Patent Application Publication
(10) Pub. No.: US 2010/0088746 A1
(43) Pub. Date: Apr. 8, 2010

(54) SECURE EBOOK TECHNIQUES

(75) Inventors: Kalyana Kota, San Diego, CA (US); Utkarsh Pandya, San Diego, CA (US); Ling Jun Wong, Escondido, CA (US)

Correspondence Address: SONY C/O MURABITO, HAO & BARNES LLP, TWO NORTH MARKET STREET, THIRD FLOOR, SAN JOSE, CA, 95113, US

(73) Assignees: SONY CORPORATION, Tokyo (JP); SONY ELECTRONICS, INC., Parkridge, CA (US)

(21) Appl. No.: 12/247,230

(22) Filed: Oct. 8, 2008

(51) Int. Cl. G06F 15/16; G06F 21/00

(52) U.S. Cl. 726/3; 709/231

(57) ABSTRACT

A computing system for delivering content includes one or more servers communicatively coupled to one or more ebooks. A given ebook may send a request for content at a specified location to a server. The request is received at the server with an identifier of the given ebook and/or user. The server determines if the ebook can access the content at the specified location based on the identifier of the ebook and/or user. If the ebook and/or user are allowed to access the content, the server streams a predetermined portion of the content to the ebook for display to a user.

### BACKGROUND OF THE INVENTION

There has always been a dilemma on how much access a user should have to confidential content, such as trade secrets and the like. The security of confidential content is often compromised, especially for smaller companies, when the secret is handed out to workers in hard copy or electronic formats. Loss or theft of such documents may often result in a leak of the confidential content. Even when the document is in a computer, the confidential content can still be easily stolen by copying it onto an external storage media. Accordingly, an affordable and more secure way is needed to keep confidential content from leaking out easily, especially by an insider.

### SUMMARY OF THE INVENTION

Embodiments of the present technology are directed toward techniques for delivering content to electronic book computing devices (ebooks). In one embodiment, a computing system for delivering content includes one or more servers communicatively coupled to one or more ebooks. The server streams a specified portion of the content on demand to the ebook, if the ebook is allowed to access the content.

In another embodiment, a request for content at a specified location is sent from an ebook to a server. The request is received at the server with an identifier of the ebook. The server determines if the ebook can access the content at the specified location based on the identifier of the ebook. If the ebook is allowed to access the content, the server streams a predetermined portion of the content to the ebook for display to a user.

In another embodiment, one or more ebooks are configured with an identifier of each piece of content on one or more servers and one or more servers are configured with an identifier of the ebooks. Thereafter, a given ebook may request a given content at a given identifier. A server, that stores the given content at the given identifier, then streams a predetermined portion of the given content to the ebook if the server is configured with the identifier of the given ebook. Upon receipt, the predetermined portion of the given content is output on the given ebook to a user.

### BRIEF DESCRIPTION OF THE DRAWINGS

Embodiments of the present technology are illustrated by way of example and not by way of limitation, in the figures of the accompanying drawings and in which like reference numerals refer to similar elements and in which:

FIG. 1 shows a computing system in accordance with one embodiment of the present technology is shown.

FIG. 2 shows a functional representation of the ebook in accordance with one embodiment of the present technology.

FIGS. 3A-3D show a method of securely accessing content on an ebook in accordance with one embodiment of the present technology.

FIGS. 4A and 4B show a method of configuring an ebook and server for securely accessing content, in accordance with one embodiment of the present technology.

### DETAILED DESCRIPTION OF THE INVENTION

Reference will now be made in detail to the embodiments of the present technology, examples of which are illustrated in the accompanying drawings. While the present technology will be described in conjunction with these embodiments, it will be understood that they are not intended to limit the invention to these embodiments. On the contrary, the invention is intended to cover alternatives, modifications and equivalents, which may be included within the scope of the invention as defined by the appended claims. Furthermore, in the following detailed description of the present technology, numerous specific details are set forth in order to provide a thorough understanding of the present technology. However, it is understood that the present technology may be practiced without these specific details. In other instances, well-known methods, procedures, components, and circuits have not been described in detail as not to unnecessarily obscure aspects of the present technology.

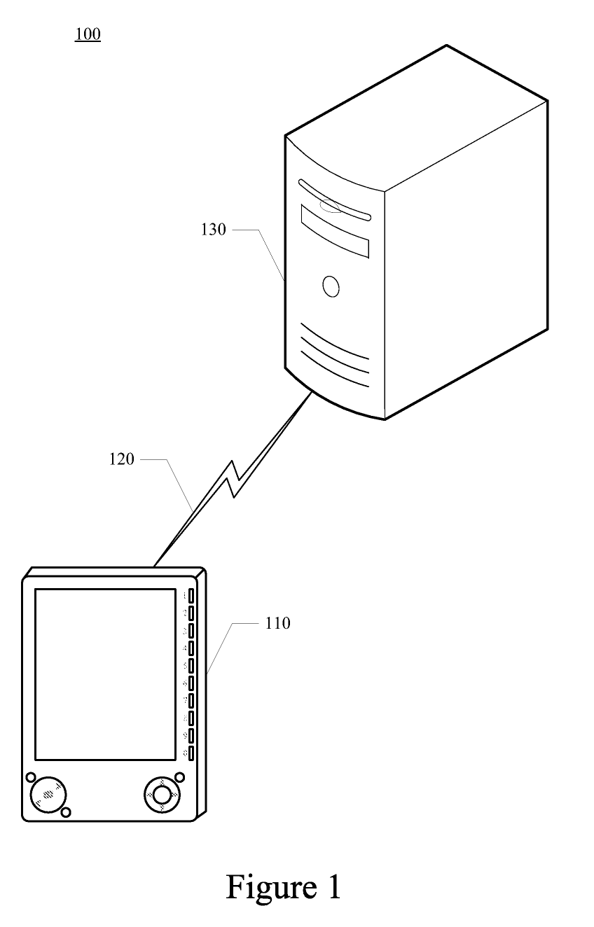

Referring now to FIG. 1, a computing system, in accordance with one embodiment of the present technology, is shown. The computing system 100 includes an electronic book computing device 110 (e.g., ebook) communicatively coupled 120 to one or more server computers 130. The ebook 110 is a hardware device, for viewing content, that is the digital equivalent of a conventional book but is typically lighter and thinner than an average paperback book. The content may be books, blogs, newspapers, magazines and the like. In one implementation, the content may be confidential content such as price lists, customer lists, technical specifications, manuals, formulas, recipes, and trade secrets. Alternatively or in addition, the content may be subscription based content.

The content for output on the ebook 110 is streamed from a server 130 as opposed to being stored locally in the ebook's memory (e.g., hard disk). In one implementation, the content is streamed over an internet connection from the server 130, and is not stored locally on the ebook 110. The content may be streamed using a streaming protocol such as user datagram protocol (UDP), real-time streaming protocol (RTSP), real-time transport protocol (RTP), transmission control protocol (TCP), unicast protocol, multicast protocol or the like.

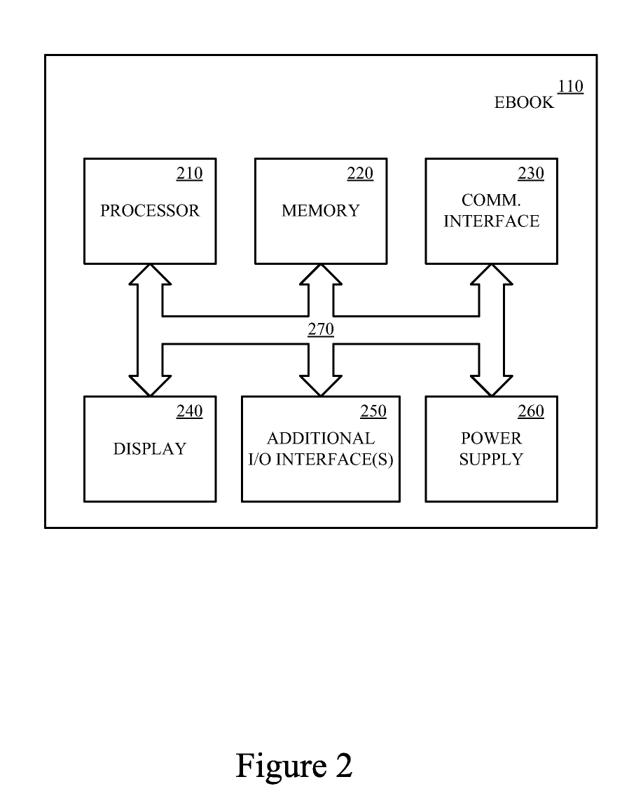

Referring now to FIG. 2, a functional representation of the ebook, in accordance with one embodiment of the present technology, is shown. The ebook 110 includes a processor 210, memory 220, a communication interface 230, a display 240, one or more additional input/out interfaces 250, and a power supply 260 coupled by one or more communication and power buses 270.

The memory 220 may be used to store one or more sets of instructions and data that, when executed by the processor 210, cause the ebook 110 to perform the functions described herein. The memory 220 may include one or more well-known computing device-readable media, such as volatile and/or non-volatile memory. The memory 220, for example, may include read only memory (ROM), random access memory (RAM), flash memory, magnetic memory (e.g., hard disk drive), optical memory (e.g., optical disk drive) and/or the like.

The memory 220 is configured so that no more than a predetermined portion of some or all received content can be stored on the ebook 110 at any given time. In particular, no more than a predetermined portion of content received from one or more predetermined servers can be stored on the ebook 110 at any given time. In another implementation, the amount of memory 220 is limited to prevent more than a predetermined portion of content from being stored on the ebook 110 at any given time.

The communication interface 230 may be a wired or wireless communication interface. For example, the communication interface 230 may be an Ethernet communication interface, third generation (3G) cellular network interface, WIFI interface, or the like that allows access to the internet, an intranet, local area network or the like. The communication interface 230 may be configured to limit access by the ebook 110, such that the ebook is restricted to send and receive data to and from one or more servers at locations specified in a configuration file. The content access configuration file, that specifies one or more servers that the ebook 110 is permitted to access, can be configured through a setup routine on a computing device that can be coupled to the ebook. Generally, the computing device used to configure the content access configuration file on the ebook 110 is controlled by the same entity that controls the server that stores particular content. The configuration file may be protected by various security techniques, such a public key encryption of the uniform resource locators (URLs) or the like.

The display 240 may be an electronic-paper or e-ink display that uses ink particles and a reflective surface that provides a sharp high-resolution screen that looks and reads like paper. The display 240 of the ebook 110 may also include a touch screen interface for inputting control commands and/or data. The touch screen may be controlled by the touch of a user or via a stylus if minimal user contact with the screen is desirable. The stylus of the touch screen display is particularly useful for operating environments where it is inconvenient for the user (e.g., a cook or mechanic) to use his/her hands to touch the screen.

The additional input/output interfaces 250 may include one or more electromechanical buttons, keys and/or switches, referred to hereinafter as interface buttons, operable to receive commands and data from a user. The interface buttons may include buttons, keys and/or switches for turning the ebook on and off, paging forward or backwards through content, jumping to a specific chapter, section, page or the like, scrolling up, down, left and right on a page, and the like. The interface buttons may include discrete buttons, multifunction buttons, context configurable buttons, and/or the like. A subset of the interface buttons may be arranged to implement a ten key pad, keyboard, and/or the like. One or more input/output interfaces 250 may be disposed on a retractable, closeable surface or the like, such as a slide out alphanumeric ten-key pad, keyboard and/or the like. The additional input/output interfaces 250 may also include speakers, a microphone, camera, or the like and/or one or more connectors for removably coupling an earphone, headphone, camera, external speaker and/or external microphone.

The power supply 260 may be a disposable battery, rechargeable battery, power chord and/or the like. The power supply 260 provides power for operation of the processor 210, memory 220, communication interface 230, display 240 and additional input/output interfaces 250.

Referring again to FIG. 1 in combination with FIG. 2, the ebook 110 sends a request via its communication interface 230 coupled to one or more networks 120 to a server 130 at a specified location for a given content. In one implementation, the content on the server 130 is specified by a uniform resource locator (URL) or the like. The server receives the request for the given content and an identifier of the ebook 110 and/or user requesting the content. The identifier of the ebook 110 may be a (MAC) address, digital certificate or the like. The identifier of the user may be a user name, password or the like. The server 130 determines whether the ebook 110 and/or user can access the given content. In one implementation, the server 130 may authenticate the ebook 110 and/or user using any well known authentication technique. The server 130 may also or in the alternative determine if the ebook 110 and/or user is authorized to access the given content using any well known authorization technique. For example, the server 130 may check if an authorization table includes an identifier of the ebook 110, such as its MAC address. If the ebook 110 and/or user can access the given content, the server 130 streams a predetermine amount of the content to the ebook 110.

The user may readily change the format of the content and/or navigate through the content, which may have all the navigation and formatting benefits of a portable document format (PDF), Microsoft word document format or the like. For example, the font size and face can be adjusted based upon the display characteristics and/or user preferences. Backlighting and special displays can allow the content to be read in low light or even total darkness. In addition, a text-to-speech application can be used to convert the text based content into an audio output. Furthermore, the ebook may be easier to use because it does not need to be held open.

Users can bookmark and annotate passages of the content. The user can also do a text search to find one or more particular passages within the content. In one implementation, the user can search the portion of the content streamed to the ebook 110. In another implementation, the user can search the entire content on the server 130. In yet another implementation, an incremental text search can be performed. For example, the text search is first performed locally on the portion of the content streamed to the ebook 110. If the local search results in a match, the results may be indicated in the currently streamed portion of the content by highlighting the matching text and/or jumping to the matching text. If the local search does not find a match, the ebook 110 may send a text search request to the server which will perform a search on the entire content and then stream another portion of the content that includes the next portion providing a match to the search request. If the result of the search on the server is also negative, the ebook 110 continues displaying the currently streamed portion of the content and an indication that no match was found for the search request.

The ebook 110 does not store more than the predetermined amount of the content in its memory 220. The predetermined portion of the content may be streamed in fixed blocks or in a moving window. For example, the server 130 may stream the content in five page blocks. The ebook 110 stores the most recent five pages of content received from the server 130 in its volatile memory. When the server 130 streams an additional five pages of the content, the ebook 110 overwrite the previous page of content with the new five pages of content received from the server. Alternatively, the server 130 may begin by steaming a first portion of the content. When the user access a page beyond a predetermine page, the ebook 110 may request that a next page be streamed. The next page streamed by the server 130 will replace the first one of the pages in the predetermined portion of the content temporarily stored on the ebook. For example, when the user access the first three pages of content streamed by the server 130 to the ebook 110, nothing happens. However, when the user access the fourth page, the ebook 110 sends a request to the server 130 for page six. The server 130 streams page six to the ebook 110 in response to the request. The ebook 110 overwrites page one, temporarily stored thereon, with page six. As a result, the current page accessed by the user is in the middle of the predetermined portion of the streamed content temporarily stored on the ebook 110. Streaming the predetermined portion of the content in a moving window may improve performance and the user experience. For example, the next page can be requested during system idle time and edge effects (e.g., where the user navigates between page 5 and 6 when pages a streamed in blocks of 5 page) can be eliminated.

In the case of a search requests, an indication of the predetermined portion of the content currently streamed to the ebook 110, at the time of the search request is made or in response to a jump to a “next” search result, may be stored on the server. Therefore, if a “back” request is received, the server 130 can re-send the particular predetermined portion of the content that was being viewed before the portion of the content containing the current search result was streamed. The content streamed in response to a search request may be streamed in block or in a sliding window as described above.

Streaming the content from the server 130 to the ebook 110 is useful for users that need access to content that may include trade secrets and other confidential information. For example, restaurant employees can access recipes and the like. Similarly, field technicians can access technical data necessary for performing their jobs. In other examples, medical personnel and legal professionals can access patient or client confidential records. In the event that the ebook is lost or stolen, the entity can simply remove the ebook's identifier, such as the ebook's MAC address, from the server thereby preventing access to content on the server. Although the user may still manually copy the data a portion at a time, the means of data possession is made harder. For example, the server may be configured to stream five pages of content at a time and the ebook may be configured to only store five pages of content at a time in volatile memory. Therefore, if the content is 100 pages long, the user would have to copy the content five pages at a time to another media. More importantly, if the ebook was lost or stolen only a portion of the content would be stored in the ebook while power was still on, and would be gone once the power was turned off if the streamed content was only buffered in volatile memory.

Similarly, streaming the content from the server to the ebook 110 is useful for delivery of subscription based content, such as news papers, magazines, journals, bulletins, prospectuses and the like. In such cases, if the user does not renew the subscription the identifier of their ebook may be removed from the subscription service's server.

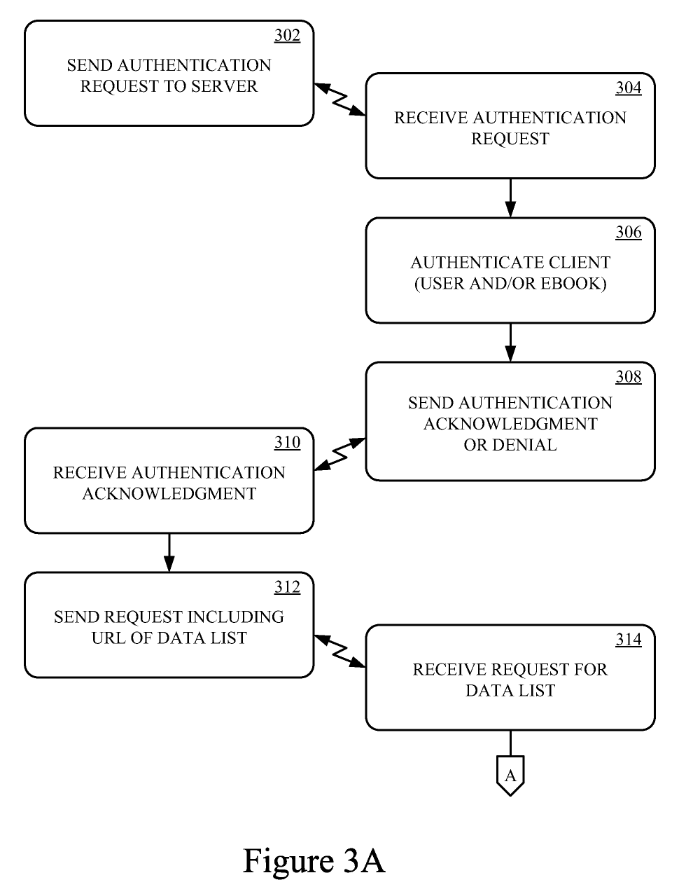

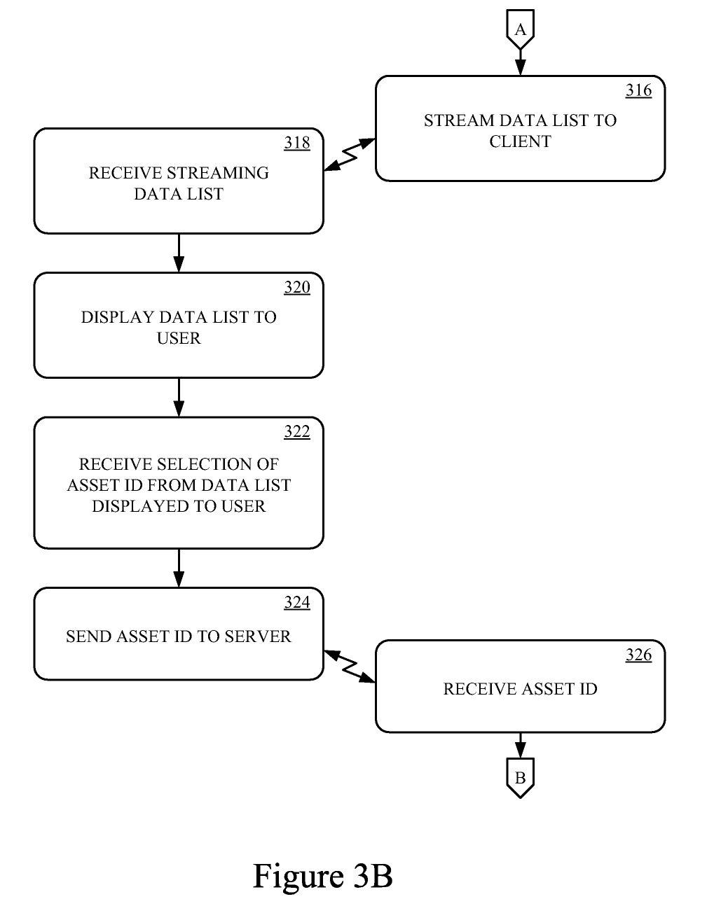

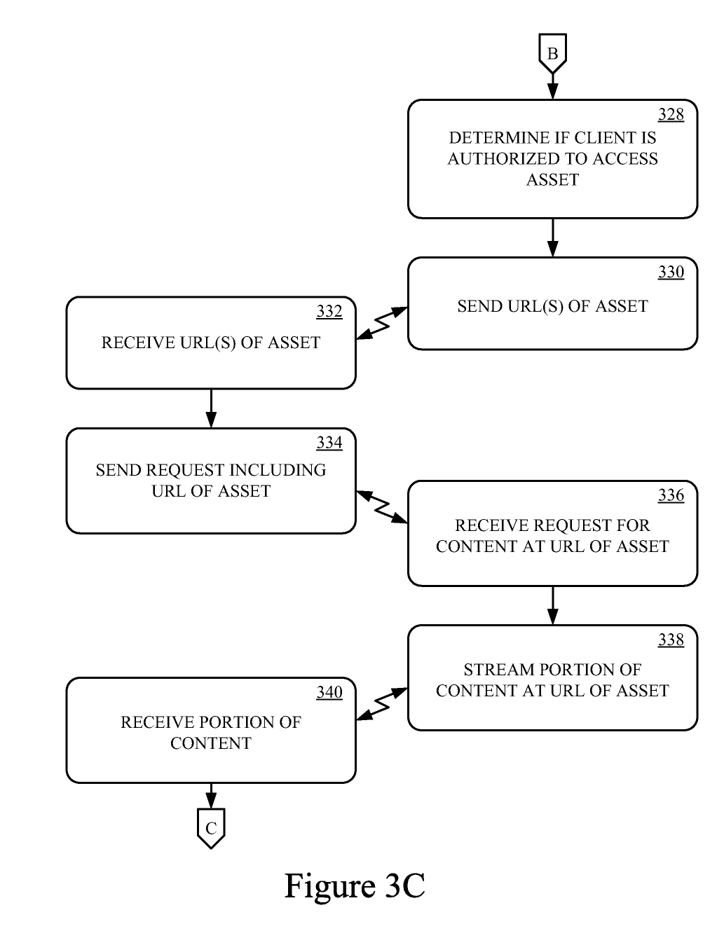

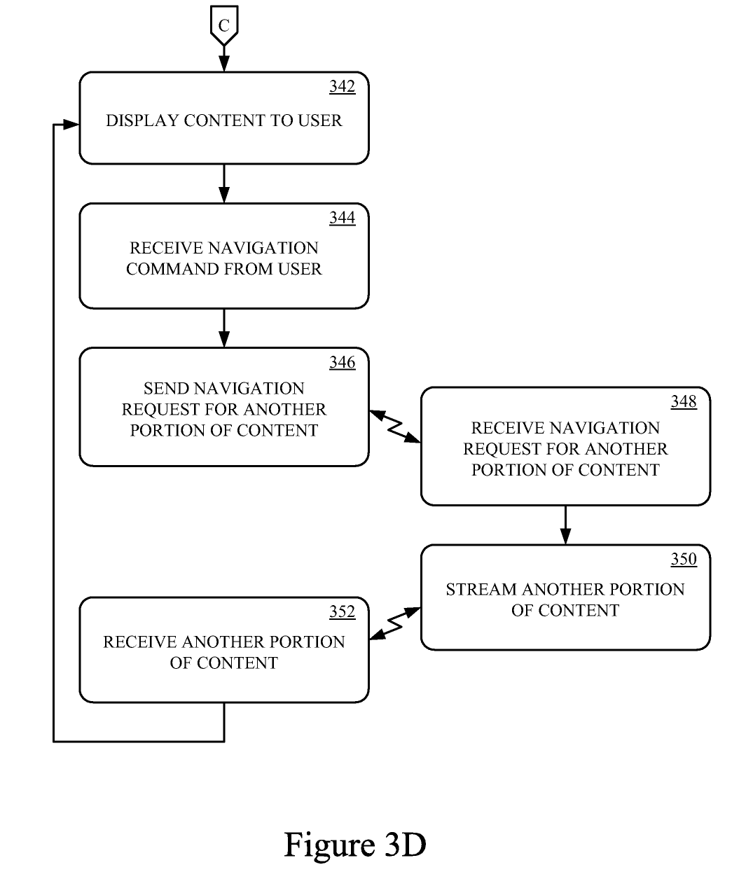

Referring now to FIGS. 3A-3D, a method of securely accessing content on an ebook, in accordance with one embodiment of the present technology, is shown. The method may begin with the ebook sending an authentication request to a server, at 302. At 304, the authentication request is received by the server. At 306, the server authenticates the client, which may be the ebook and/or the user of the ebook. At 308, the server sends an authentication acknowledgement to the ebook if the client is authenticated. Alternatively, the server may send a message indicating that the client has not been authenticated and that access to resources on the server is denied.

The ebook receives the client authentication acknowledgement or denial, at 310. At 312, the ebook sends a request, including a resource indicator to the server if the client was authenticated. At 314, the request including the resource indicator is received by the server. At 316, a data list is streamed to the ebook in response to receipt of the resource indicator. At 318, the ebook receives the streaming data list from the server. At 320, the data list is output to the user on one or more user interfaces of the ebook. At 322, selection by the user of an asset identifier from the data list is received on one or more user interfaces of the ebook. At 324, the selected asset identifier is sent from the ebook to the server.

At 326, the server receives the asset identifier. At 328, the server may determine if the client is authorized to access the asset. At 330, a resource identifier of the selected asset is sent to the ebook. At 332, the ebook receives the resource identifier of the selected asset. At 334, the ebook sends a request including the resource identifier of the selected asset to the server.

At 336, the server receives the request for the content at the resource identifier of the selected asset. At 338, the server streams the content at the resource identifier to the ebook one portion at a time. At 340, the ebook receives the portion of the content streamed from the server. The content is streamed from the server and is not stored locally on the ebook. At 342, the ebook outputs the portion of the content on one or more input/output interfaces. The user may readily navigate through the content, which may have all the navigation benefits of a portable document format (PDF), Microsoft word document format or the like, at 344. If a navigation request is received for another portion of the content, the ebook sends a navigation request for another portion of the content, at 346. At 348, the server receives the navigation request for another portion of content. At 350, the server streams the other portion of the content to the ebook. At 352, the other portion of content is received by the ebook. The other portion of the content may then be displayed and navigated within in accordance with processes 342-352.

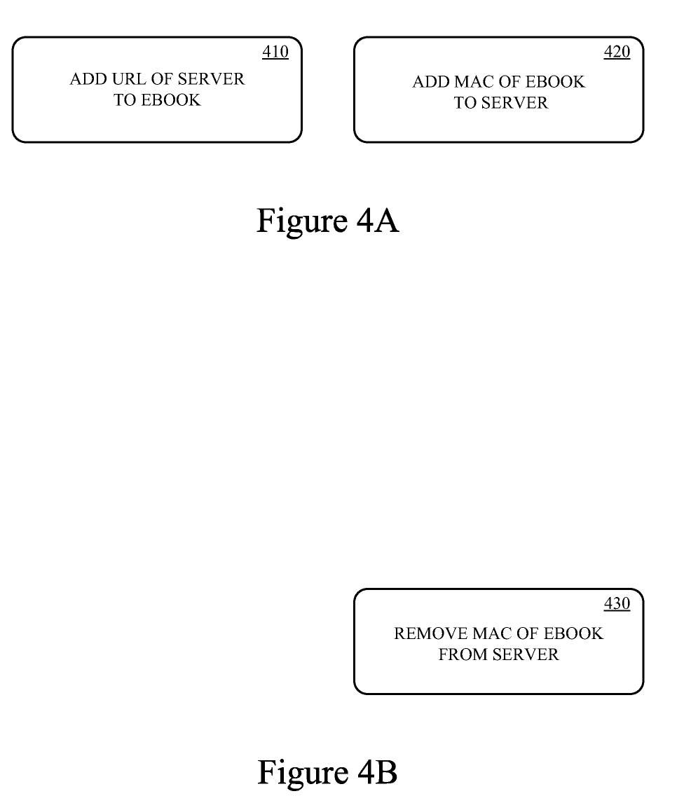

Referring now to FIGS. 4A and 4B, a method of configuring an ebook and server for securely accessing content, in accordance with one embodiment of the present technology, is shown. As depicted in FIG. 4A, an identifier of a server is added to an ebook, at 410. In one implementation, a uniform resource locator (URL) or the like on the server is stored in a configuration file of the ebook. The URL may be loaded on the ebook by coupling it to a given computer under control of the entity that implements a setup application for loading the identifier of the server on the ebook. At 420, an identifier of the ebook is added to the server. In one implementation, the (MAC) address or the like of the ebook is added to an authorization/authentication client table of the server. In the event that the ebook is lost or stolen, the entity can simply remove the MAC address of the ebook from the server as depicted at 430 in FIG. 4B. The ebook is therefore rendered useless for accessing the secure content on the server.

Embodiments of the present technology may advantageously be utilized to protect trade secrets and other confidential content. Users who require access to confidential content are able to access the required content using electronic navigation and search techniques. Embodiments also offer a mobile, lightweight, condensed and secure solution for accessing content The ebook is useful for users such as a salesman who wish to easily access their content such as client lists when they are constantly on the move, but at the same time, wish to keep the content secure in the event that the ebook is lost or stolen. In the event that the ebook reader is lost or stolen, removing the identifier of the ebook from the server renders the ebook useless as it can no longer access the content.

The foregoing descriptions of specific embodiments of the present technology have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is intended that the scope of the invention be defined by the Claims appended hereto and their equivalents.

What is claimed is:

1. A system comprising:
an electronic book computing device; and
a server for streaming content to the electronic book computing device if the electronic book computing device is allowed to access the content.

2. The system of claim 1, wherein the electronic book computing device comprises memory configured to store no more than a predetermined portion of the content streamed from the server.

3. The system of claim 1, wherein the electronic book computing device comprises a communication interface configured to limit access by the electronic book computing device to one or more predetermined servers.

4. The system of claim 1, wherein the content comprises confidential content.

5. The system of claim 1, wherein the content comprises subscription based content.

6. One or more computing device readable media including computing device executable instructions which when executed by one or more processor cause one or more computing devices to implement a method comprising:
sending a request for a content at a specified location from an ebook to a server;
receiving the request with an identifier of the ebook at the server;
determining at the server if the ebook can access the content at the specified location based on the identifier; and
streaming a predetermined portion of the content from the server to the ebook if it is determined that the ebook can access the content.

7. The one or more computing device readable media implementing the method according to claim 6, wherein the location of the content is specified by a uniform resource locator.

8. The one or more computing device readable media implementing the method according to claim 6, wherein the identifier of the ebook comprises a media access control (MAC) address.

9. The one or more computing device readable media implementing the method according to claim 8, wherein determining if the ebook can access the content at the specified location comprises determining if an authorization table of the server includes the media access control (MAC) address of the ebook.

10. The one or more computing device readable media implementing the method according to claim 6, wherein access by the ebook is prevented by removing the media access control (MAC) address of the ebook from the authorization table.

11. The one or more computing device readable media implementing the method according to claim 6, wherein the media access control (MAC) address of the ebook is removed from the authorization table if the ebook is lost or stolen.

12. The one or more computing device readable media implementing the method according to claim 6, wherein the ebook does not store more than the predetermined portion of the content.

13. The one or more computing device readable media implementing the method according to claim 2, wherein the ebook overwrites a previously received predetermined portion of the content with a next received predetermined portion of the content.

14. A method comprising:
configuring one or more ebooks with an identifier of each of one or more content on one or more servers;
configuring the one or more servers with an identifier of the one or more ebooks;
requesting by a given ebook a given content at a given identifier;
streaming to the given ebook a predetermined portion of the given content from a given server including the given content at the given identifier if the server is configured with the identifier of the given ebook; and
outputting the predetermined portion of the given content on the given ebook to a user.

15. The method according to claim 14, wherein requesting the given content comprises:
sending an authentication request from the ebook to the server;
authenticating by the server a client in response to the authentication request;
sending an authentication acknowledgment from the server to the ebook if the client is authenticated;
sending a request including a uniform resource location of a data list from the ebook to the server in response to the authentication acknowledgment;
streaming the data list from the server to the client in response to the request including the uniform resource location;
displaying the data list on the ebook to a user;
receiving a selection of an asset identifier included in the data list on the ebook from a user;
sending the asset identifier from the ebook to the server;
determining by the server if the client is authorized to access the asset at the asset identifier;
sending one or more uniform resource locators corresponding to the asset identifier from the server to the ebook if the client is authorized to access the asset; and
sending a request including one or more uniform resource locators of the asset from the ebook to the server.

16. The method according to claim 15, wherein:
the client is authenticated based on the media access control (MAC) address of the ebook; and
determining if the client is authorized to access the asset is based on the media access control (MAC) address of the ebook.

17. The method according to claim 15, wherein streaming a predetermined portion of the given content from the server to the ebook comprises:
streaming the predetermined portion of the given content at the one or more uniform resource locators corresponding to the asset from the server to the ebook;
displaying the predetermined portion of the given content on the ebook to the user.

18. The method according to claim 17, wherein streaming a predetermined portion of the given content from the server to the ebook further comprises:
receiving a navigation command on the ebook from the user;
displaying the predetermined portion of the given content on the ebook to the user based on the navigation command.

19. The method according to claim 17, wherein streaming a predetermined portion of the given content from the server to the ebook further comprises:
sending a request for another portion of the given content from the ebook to the server, if the navigation command is for another portion of the given content;
streaming another portion of the given content from the server to the ebook in response to the request for another portion of the content, wherein current portion of the content overwrites the previous portion of content on the ebook.

20. The method according to claim 14, further comprising removing the identifier of a particular ebook from the one or more servers if the particular ebook is lost or stolen.
